(19) United States
(12) Patent Application Publication
(10) Pub. No.: US 2025/0387860 A1
(43) Pub. Date: Dec. 25, 2025

(54) SUBSTRATE HOLDERS, SUBSTRATE HOLDER FIXTURES, AND METHODS FOR USING THE SAME

(71) Applicant: The University of Toledo, Toledo, OH (US)

(72) Inventors: Emanuela Gionfriddo, Toledo, OH (US); Jason Bolbach, Toledo, OH (US); Ronald Emmons, Toledo, OH (US); Isaac Kim, Toledo, OH (US)

(73) Assignee: The University of Toledo, Toledo, OH (US)

(21) Appl. No.: 19/244,254

(22) Filed: Jun. 20, 2025

Related U.S. Application Data
(60) Provisional application No. 63/663,452, filed on Jun. 24, 2024.

(51) Int. Cl. B23Q 3/18

(52) U.S. Cl. CPC B23Q 3/18

(57) ABSTRACT

Substrate holders, substrate holder fixtures, and methods for using the substrate holders and substrate holder fixtures are described.

### RELATED APPLICATIONS

This application claims priority to U.S. Provisional Application No. 63/663,452 filed under 35 U.S.C. § 111 (b) on Jun. 24, 2024, the disclosure of which is incorporated herein by reference in its entirety.

### STATEMENT REGARDING FEDERALLY SPONSORED RESEARCH

This invention was made with no government support. The government has no rights in this invention.

### BACKGROUND

Thin films have diverse applications across numerous industries due to their unique properties and versatility. For example, thin films are used in optical coatings to control the reflection, transmission, and absorption of light, making them essential for lenses, mirrors, and displays. Thin films also find applications in electronics and protective coatings for enhancing surface durability, sensors for detecting gases and biological molecules, and batteries for portable electronics. From microelectronics to packaging materials, thin films continue to drive innovation and enable technological advancements across a wide range of fields.

The development of a device capable of holding thin films for stress tests or biofouling experiments is of paramount importance for several reasons. First, such a device facilitates the evaluation of the mechanical properties of thin films under different stress conditions, helping researchers understand their durability and reliability in real-world applications. In biofouling experiments, where the accumulation of microorganisms or other biological matter on surfaces is studied, a dedicated device enables researchers to assess the effectiveness of various anti-fouling coatings or cleaning methods. This is valuable for marine industries, where biofouling can lead to increased fuel consumption and maintenance costs for ships and offshore structures. Overall, a specialized device for holding thin films in stress tests or biofouling experiments empowers researchers to advance materials science and engineering, leading to the development of more durable, efficient, and environmentally friendly products and technologies.

Thin films are highly useful in extraction techniques due to their unique properties, such as high surface area, controlled thickness, and tunable chemical composition. The versatility of thin films also allows for customization to suit specific extraction needs, making them valuable in fields ranging from environmental cleanup to pharmaceutical purification. Thin films play a significant role in analytical extractions, where they are used as stationary phases in techniques such as thin-layer chromatography (TLC) and solid-phase microextraction (SPME). In TLC, a thin film coated on a solid support serves as the stationary phase through which the analytes migrate, allowing for separation based on their affinity for the stationary phase versus the mobile phase. Similarly, in SPME, a thin film coating on a fiber substrate acts as a sorbent for extracting analytes from liquid or gas samples. Other thin film extraction techniques include thin film evaporation, membrane distillation, liquid-liquid extraction, microextraction by packed sorbent (MEPS), and fabric phase sorptive extraction (FPSE) (in which a coated fabric acts as the extraction medium). Thin films in analytical extractions offer advantages such as high surface area, rapid extraction kinetics, and compatibility with a wide range of analytes, making them invaluable tools for analytical chemists in diverse fields such as environmental monitoring, food safety, and forensic analysis.

Under the SPME umbrella, as one example, there are many geometries for extraction devices. Thin film SPME is one of the geometries commonly used and involves an extraction phase that is a thin film. Thin films are commonly made of Carboxen™ (CAR), or Divinyl Benzene (DVB) particles embedded in a Polydimethylsiloxane (PDMS) support. DVB offers the ability to adsorb analytes onto the surface of particles due to the phenyl groups creating pi interactions. Carboxen™ is a proprietary mesh produced by SUPELCO but in general carbon meshes are large carbon skeletons, like graphene, with large pores or other heteroatoms incorporated during the construction to create a desired effect. Thin film SPME as a technique offers faster extractions in comparison to other SPME methods due to reaching an equilibrium faster in part due to the greater surface area. The greater surface area helps more analytes diffuse onto/into the extraction phase. This makes it an ideal geometry for onsite extractions as more analytes can be extracted by users in a shorter time period.

Conventional holders for thin film SPME devices can have drawbacks, especially when considering use in onsite extractions. For example, one commercial holder which is designed for in-vial extractions makes a small connection to pinch the thin film and hold it in place. While this small connection can be safe, there is little support protecting the thin film from bending or slipping off during extraction especially under more vigorous extraction conditions. The bending causes extractions to be less reproducible as the extraction phase is no longer uniformly in contact with the sample thus disrupting the diffusion of analytes onto the extraction phase. The bending can also lead to the thin film from being completely released from the holder which prevents proper extraction in vial, or worse, completely loses the extraction device onsite. Another common holder is the industrial fastener, cotter pins, which have been used for extractions, especially onsite, due to the tighter grip on the film that is achieved. Cotter pins typically improve on some of the security issues seen with the commercial holders but pose a much greater risk of damaging the thin film device. Cotter pins pinch the film much tighter and as a result can damage the thin film device like fraying the gripped end or even piercing the film. Cotter pins also require the user to expose the same amount of the film each time so that there is a uniform amount of extraction phase available for a reproducible extraction.

There remains a need in the art for new and improved substrate holders for substrates, such as thin films.

### SUMMARY

Provided herein is a substrate holder comprising a first body having a first locking portion, a first substrate portion, a first cross member, and a second cross member, the first substrate portion defining a first window, wherein the first cross member and the second cross member extend across the first window; and a second body having a second locking portion, a second substrate portion, and a third cross member, the second substrate portion defining a second window; wherein the third cross member and the fourth cross member extend across the second window, wherein when the second body is disposed on the first body, the first locking portion and the second locking portion mate together to form a substrate holder stem, the first cross member is spaced apart from the third cross member, and the second cross member is spaced apart from the fourth cross member.

In certain embodiments, the second locking portion is a locking member and the first locking portion defines a first groove configured to receive the locking member when the first body is disposed on the second body.

In certain embodiments, the first substrate portion defines a third window formed adjacent to the first window and the second substrate portion defines a fourth window adjacent to the second window.

In certain embodiments, the substrate holder further comprises a cap configured to receive at least a portion of the substrate holder stem. In particular embodiments, the cap defines a substantially s-shaped void.

In certain embodiments, the first body has a first arm and a second arm that curve towards each other and the second body has a third arm and a fourth arm that curve towards each other.

In certain embodiments, the first body further comprises a third locking portion, and wherein the first substrate portion is between the first locking portion and the third locking portion. In particular embodiments, the third locking portion of the first body defines a second groove configured to receive at least an edge of the second body. In particular embodiments, the third locking portion of the first body includes a lip oriented perpendicular to the first substrate portion and the second groove is formed in the lip of the first body.

In certain embodiments, the substrate holder further comprises a substrate holder fixture having a circular base with a fixture stem, the circular base defining a stem slot configured to receive the substrate holder stem. In particular embodiments, the circular base defines a locking aperture in communication with the stem slot, the aperture configured to receive a locking screw. In particular embodiments, the circular base defines a plurality of stem slots spaced apart from each other.

Further provided herein is a substrate holder comprising a main body; a first substrate arm extending from the main body, the first substrate arm having a first flex portion defining a second substrate arm facing side, a first end portion defining a first substrate side opposite to the second substrate arm facing side, and a first intermediate portion sloped from the first flex portion towards the first end portion, the first intermediate portion defining an arm window; and a second substrate arm extending from the main body, the second substrate arm having a second flex portion spaced apart from the first flex portion to define a first gap therebetween, the second flex portion defining a first substrate arm facing side, a second end portion defining a second substrate side opposite to the first substrate arm facing side, the second substrate side facing the first substrate side, and a second intermediate portion sloped from the second flex portion towards the second end portion and extending through the arm window of the first substrate arm, wherein the first end portion and the second end portion are configured to receive and sandwich a substrate, and wherein compressing the first flex portion and the second flex portion causes the first end portion and the second end portion to be spaced apart from each other.

In certain embodiments, the substrate holder further comprises a cap disposed at an end of the main body opposite to the first substrate arm and the second substrate arm.

In certain embodiments, the substrate holder further comprises an enclosure disposed over at least the first substrate arm and the second substrate arm. In particular embodiments, an end of the enclosure defines a slot formed adjacent to the first end portion of the first substrate arm and the second end portion of the second substrate arm, and wherein the slot is configured to receive at least a portion of the substrate when the portion of the substrate is received by the first end portion and the second end portion.

In certain embodiments, the substrate holder further comprises a collar circumscribing the main body. In particular embodiments, the collar has an inner ring circumscribing the main body. In particular embodiments, the collar has an outer ring spaced apart from the inner ring to form a second gap therebetween.

In certain embodiments, the substrate holder further comprises a sheath covering at least a substrate where the substrate is received by the first substrate arm and the second substrate arm.

In certain embodiments, a substrate holder fixture comprising a circular base having a first face, a second face, and an edge between the first face and the second face, the first face having a fixture stem, and the second face defining a stem slot configured to receive the substrate holder stem, and the edge defining an aperture in communication with the stem slot, the aperture configured to receive a locking screw.

In certain embodiments, a method for using a substrate holder comprising: applying a substrate over a first window of a first body of the substrate holder, the first body having a first locking portion, a first substrate portion, a first cross member, a second cross member, the first substrate portion defining the first window, wherein the first cross member and the second cross member extend across the first window; and connecting a second body of the substrate holder to the first body, the second body having a second locking portion, a second substrate portion, a third cross member, and a third cross member, the second substrate portion defining a second window, wherein the third cross member and the fourth cross member extend across the second window, whereby when the second body is connected to the first body, the first locking portion and the second locking portion mate together to form a substrate holder stem, the first cross member is spaced apart from third cross member, and the second cross member is spaced apart from the fourth cross member.

In certain embodiments, the second locking portion is a locking member and the first locking portion defines a first groove, and whereby connecting the second body to the first body causes the first groove to receive the locking member.

In certain embodiments, the first body has a first arm and a second arm that curve towards each other and the second body has a third arm and a fourth arm that curve towards each other, and wherein the method further comprises introducing a stir bar between the first arm and the second arm.

In certain embodiments, the first body further comprises a third locking portion, and wherein the first window is formed between the first locking portion and the third locking portion, wherein the third locking portion of the first body defines a second groove configured to receive at least an edge of the second body, and whereby connecting the second body to the first body causes the second groove to receive an edge of the second body.

In certain embodiments, the method further comprises inserting the substrate holder in a sample comprising analytes. In particular embodiments, the sample is a body of water.

Further provided herein is a method for using a substrate holder comprising compressing a first flex portion and a second flex portion of the substrate holder, the substrate holder comprising a main body; a first arm extending from the main body, the first arm having the first flex portion defining a second arm facing side, a first end portion defining a first substrate side opposite to the second arm facing side, and a first intermediate portion sloped from the first flex portion towards the first end portion, the first intermediate portion defining a window; and a second arm extending from the main body, the second arm having the second flex portion spaced apart from the first flex portion to define a first gap therebetween, the second flex portion defining a first arm facing side, a second end portion defining a second substrate side opposite to the first arm facing side, the second substrate side facing the first substrate side, and a second intermediate portion sloped from the second flex portion towards the second end portion and extending through the window of the first arm, whereby compressing the first flex portion and the second flex portion causes the first end portion and the second end portion to be spaced apart from each other to form a substrate gap therebetween; inserting a portion of a substrate into the gap between the first end portion and the second end portion; and releasing the first flex portion and the second flex portion, whereby releasing the first flex portion and the second flex portion causes the first end portion and the second end portion to sandwich the portion of the substrate therebetween.

In certain embodiments, the substrate holder further comprises a cap disposed at an end of the main body opposite to the first arm and the second arm.

In certain embodiments, the substrate holder further comprises an enclosure disposed over at least the first arm and the second arm. In particular embodiments, an end of the enclosure defines a slot formed adjacent to the first end portion of the first arm and the second end portion of the second arm, and wherein the slot is configured to receive the portion the substrate where the portion of the substrate is received by the first end portion and the second end portion. In particular, the substrate holder further comprises a collar circumscribing the main body. In particular embodiment, the collar has an inner ring circumscribing the main body. In particular embodiments, the collar has an outer ring spaced apart from the inner ring to form a second gap therebetween.

In certain embodiments, the substrate holder further comprises disposing a sheath over at least the substrate.

In certain embodiments, the method further comprises inserting the substrate into a sample comprising analytes. In particular embodiments, the method further comprises compressing the first flex portion and the second flex portion of the substrate holder, whereby compressing the first flex portion and the second flex portion causes the first end portion and the second end portion to be spaced apart from each other to release the substrate from the first end portion and the second end portion. In particular embodiments, the sample is a body of water.

Further provided herein is a method for using a substrate holder fixture, the method comprising inserting a stem of a substrate holder into a stem slot of a substrate holder fixture, the substrate holder fixture comprising a circular base having a first face, a second face, and an edge between the first face and the second face, the circular base defining the stem slot configured to receive the substrate holder stem, and the edge defining an aperture in communication with the stem slot, the aperture configured to receive a locking screw; connecting the substrate holder fixture to a drill; inserting the substrate holder fixture into a sample comprising analytes; and driving the drill to rotate the substrate holder fixture in the sample.

Advantageously, the substrate holders and methods described herein can offer enhanced protection for substrates, such as thin films, and facilitate more reproducible extractions compared to other holders under similar extractions conditions. The substrate holder allows users to employ thin film SPME devices for both in-lab and on-site extractions while militating against the risk of loss or damage to the thin film. Also, the substrate holder can facilitate reproducible extractions at high flows without altering the original structure of the thin film.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1: Perspective view of a first body of a substrate holder, according to some embodiments of the present disclosure.

FIG. 2: Perspective view of a second body of a substrate holder, according to some embodiments of the present disclosure.

FIG. 3: Perspective view of the substrate holder, including the first body shown in FIG. 1, the second body shown in FIG. 2, and a cap.

FIG. 4: Top plan view of the substrate holder shown in FIG. 3.

FIG. 5: Top plan view of the cap of the substrate shown in FIG. 4.

FIG. 6: Perspective view of a first body of a substrate holder, according to some embodiments of the present disclosure.

FIG. 7: Perspective view of a second body of a substrate holder, according to some embodiments of the present disclosure.

FIG. 8: Perspective view of the substrate holder, including the first body shown in FIG. 6, the second body shown in FIG. 7, and a cap.

FIG. 9: Perspective view of a first body of a substrate holder, according to some embodiments of the present disclosure.

FIG. 10: Perspective view of a second body of a substrate holder, according to some embodiments of the present disclosure.

FIG. 11: Perspective view of a first body of the substrate holder, according to some embodiments of the present disclosure.

FIG. 12: Side elevational view of the first body of the substrate holder shown in FIG. 11.

FIG. 13: Front plan view of a second body of a substrate, according to some embodiments of the present disclosure.

FIG. 14: Perspective view of the substrate holder, including the first body shown in FIG. 12 and the second body shown in FIG. 13.

FIG. 15: Perspective view of a substrate holder fixture, according to some embodiments of the present disclosure.

FIG. 16: Side elevational view of a substrate holder fixture, according to some embodiments of the present disclosure.

FIG. 17: Bottom plan view of the substrate holder fixture shown in FIG. 16.

FIG. 18: Perspective view of a substrate holder holding a substrate, according to some embodiments of the present disclosure.

FIG. 19: Side elevational view of the substrate holder shown in FIG. 18 with a collar and an enclosure.

FIG. 20: Side elevational view of the substrate holder shown in FIG. 19 without the substrate.

FIG. 21: Perspective view of the substrate holder shown in FIG. 20.

FIG. 22: Bottom plan view of the substrate holder shown in FIG. 21.

FIG. 23: Perspective view of the substrate holder shown in FIG. 21 holding the substrate with a sheath disposed over the substrate.

FIG. 24: Table showing chemical standards used with chemical properties and structures. Log P and pKa values were found using Chemicalize software.

FIG. 25: Chart showing substrate holder comparisons for an agitation speed of 600 RPM.

FIG. 26: Chart showing substrate holder comparisons for an agitation speed of 900 RPM.

FIG. 27: Chart showing substrate holder comparisons for an agitation speed of 1200 RPM.

FIG. 28: Table showing the calculated reproducibility (% RSD) of holders across extraction speeds and analyte.

FIG. 29: Naming system for thin film arrangements.

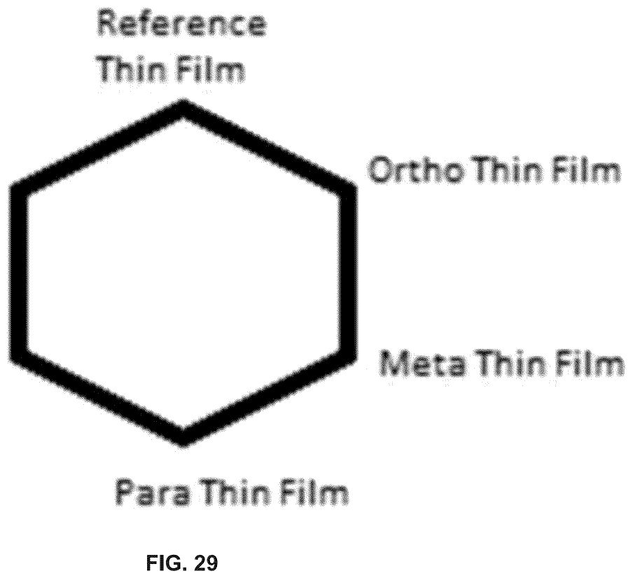

FIG. 30: Chart showing the thin film (TF) interference comparison.

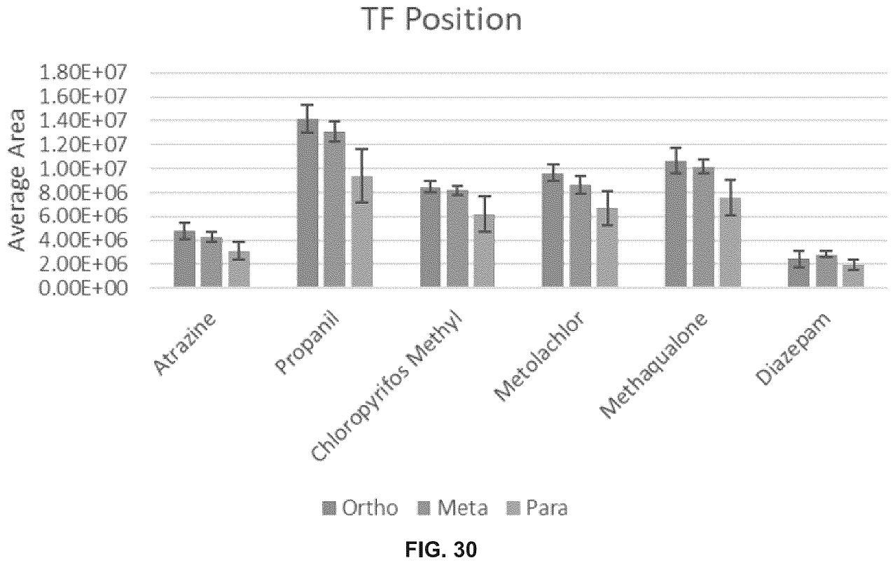

FIG. 31: Table showing the reproducibility of thin film (TF) positional interference.

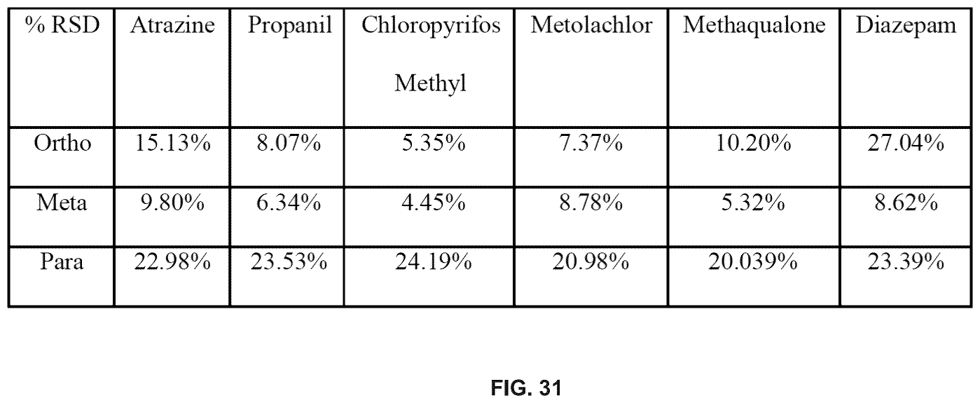

FIG. 32: Table showing polymer leaching across solution temperature, pH, and salinity.

FIG. 33: Cross-sectional view of a substrate holder, according to some embodiments of the present disclosure.

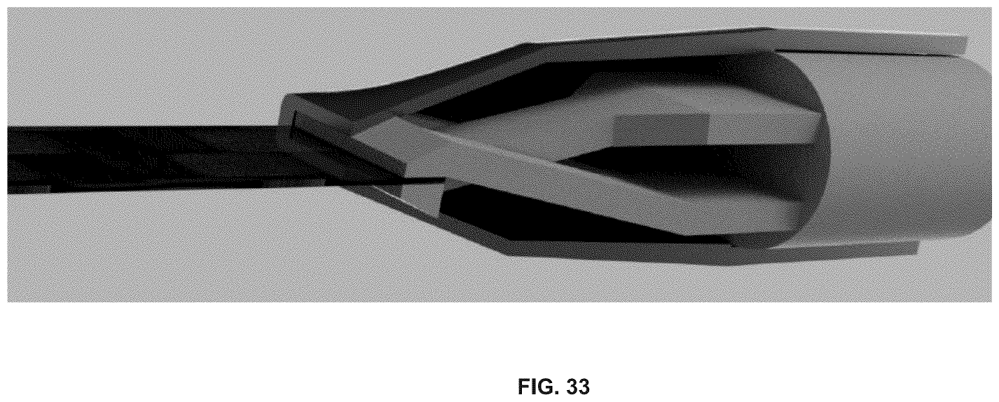

FIG. 34: Perspective view of a substrate holder, according to some embodiments of the disclosure.

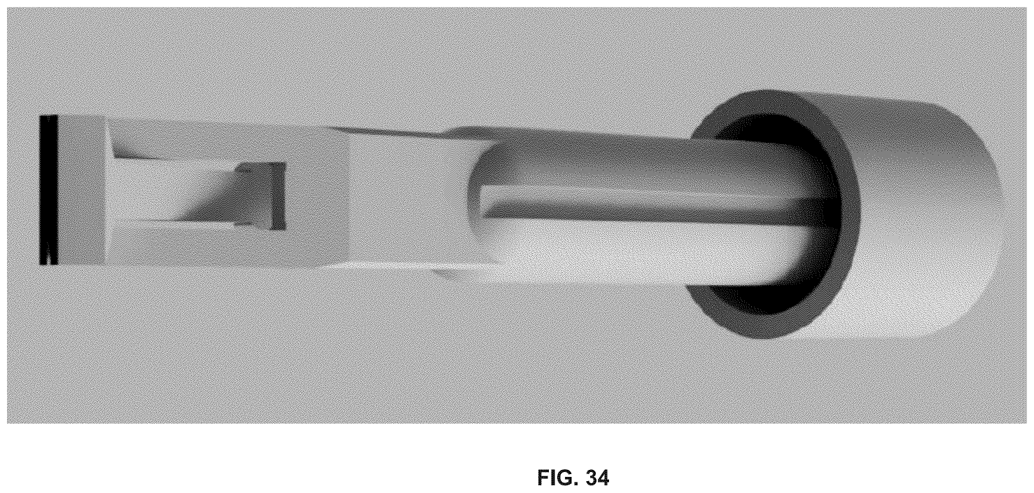

FIG. 35: Photograph of a substrate holder, according to some embodiments of the present disclosure.

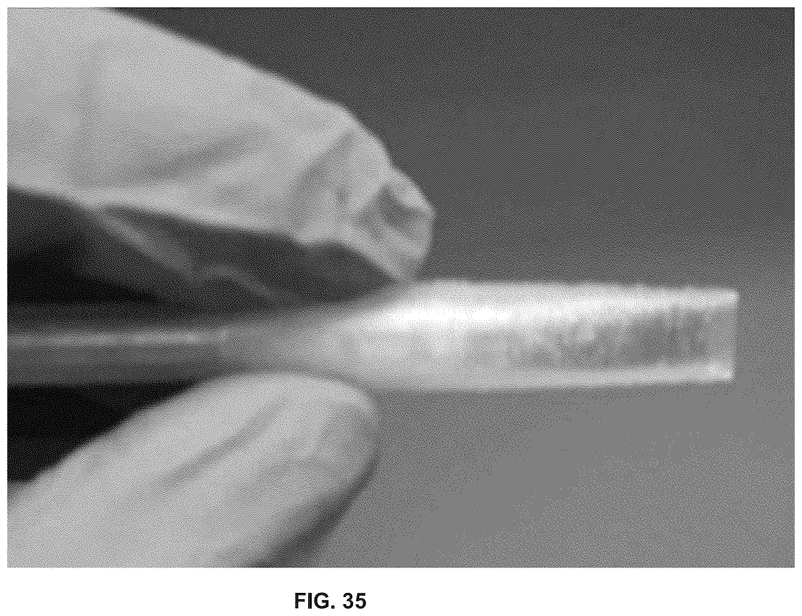

FIG. 36: Photograph of the substrate holder shown in FIG. 35 holding a substrate.

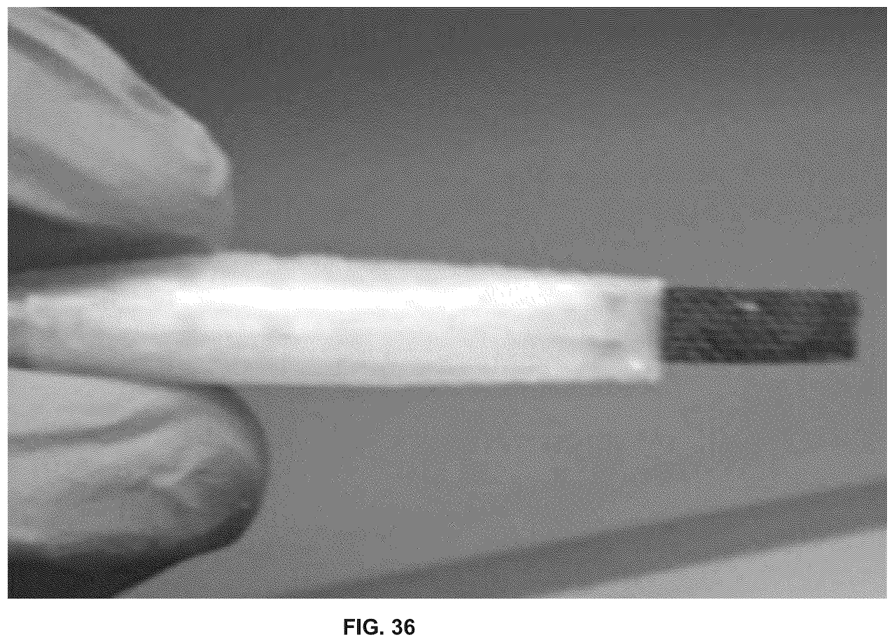

FIG. 37: Photograph of a substrate holder, according to some embodiments of the present disclosure.

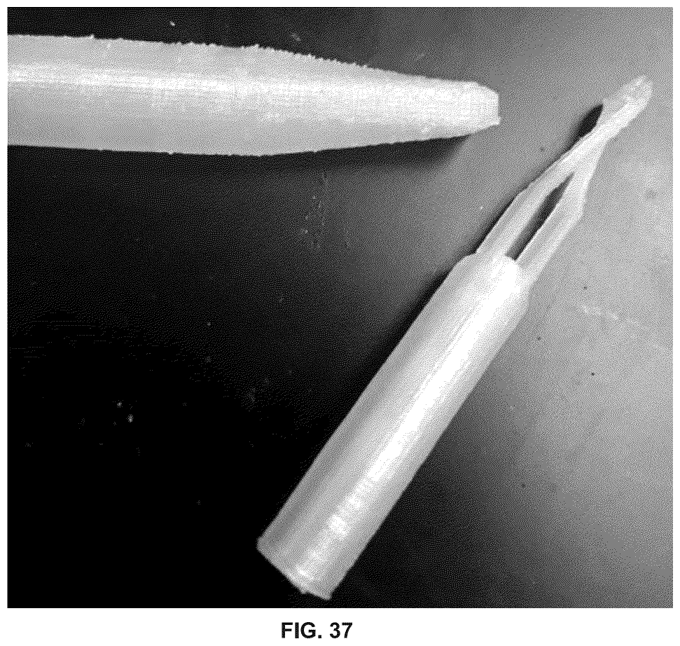

FIG. 38: Photograph of substrate holders, according to some embodiments of the present disclosure.

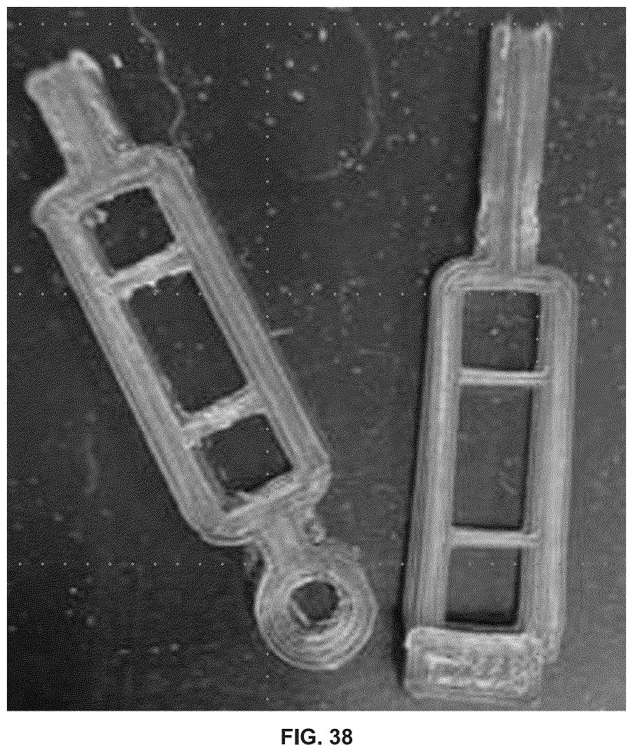

### DETAILED DESCRIPTION

Throughout this disclosure, various publications, patents, and published patent specifications are referenced by an identifying citation. The disclosures of these publications, patents, and published patent specifications are hereby incorporated by reference into the present disclosure in their entirety to more fully describe the state of the art to which this invention pertains.

When using thin film SPME for extractions, users are often limited to commercial holders that do not function properly at higher extraction speeds (e.g., >1000 rpm) or utilitarian solutions such as cotter pins that can risk damaging the thin film SPME device. With conventional commercial substrate holders, the thin film can bend, which leads to worse extraction performances, or the thin film can slip from the substrate holder completely, which can cause damage to the thin film in a vial, or it can be lost completely during onsite sampling. Cotter pins and similar holders may pinch the film too tightly, which can fray the ends of the film, or worse, the cotter pin can completely pierce the film. In either case, the film can be rendered useless as result of the damage. Provided herein are substrate holders which can address these issues.

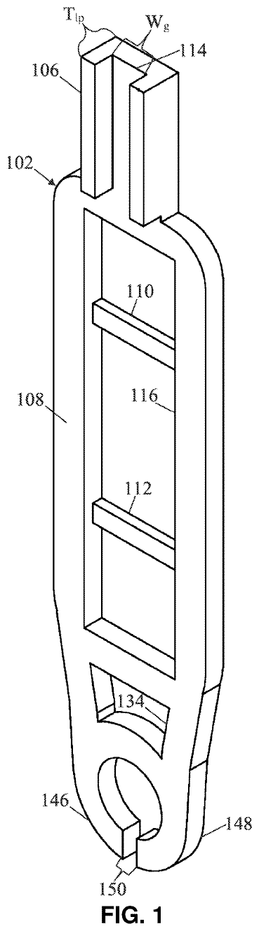

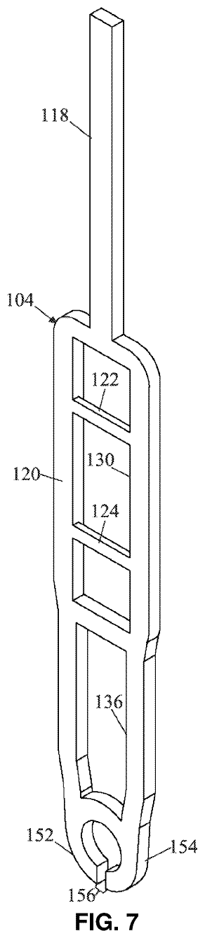

With collective reference to FIGS. 1-14, a substrate holder 100 configured to receive and hold a substrate 101, such as a thin film (TF), is shown. When the substrate 101 is held by the substrate holder 100, the substrate holder 100 can be disposed within a sample to facilitate analytes in the sample being adsorbed or absorbed by the substrate 101. The sample may be a fluid within a vial, gas sampling bulb, or even a body of water, such as a river, lake, or the like.

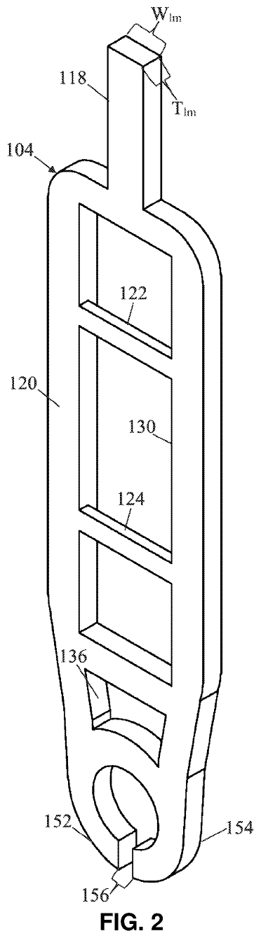

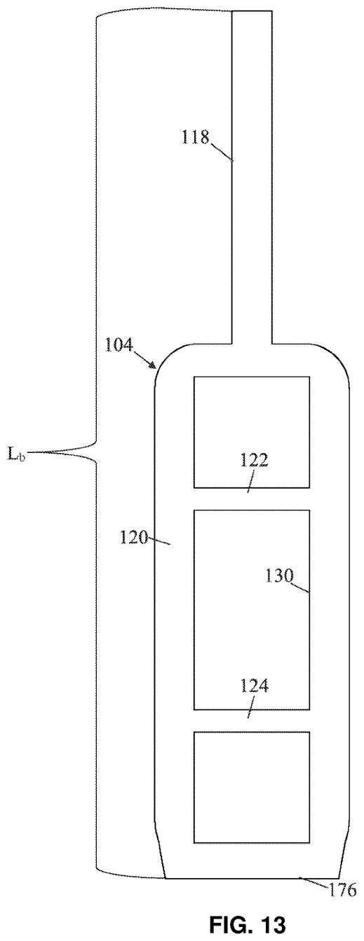

Referring to FIGS. 1-2, the substrate holder 100 can include a first body 102, e.g., as shown in FIG. 1, and a second body 104, e.g., as shown in FIG. 2. The first body 102 and the second body 104 can be composed of polylactic acid (PLA) filament. However, it should be appreciated that the first body 102 and the second body 104 can be composed of different materials, for example, acrylonitrile butadiene styrene (ABS), polyethylene terephthalate glycol (PETG), nylon, thermoplastic polyurethane (TPU), metals, 3D printed metals, and other polymers, resins, composites, or combinations thereof. In addition, the substrate holder 100 can be manufactured via 3D printing, or other processes. With reference to FIG. 13, in certain examples, the first body 102 and the second body 104 have a length L_{b} in a range from about 21 mm to about 136 mm, from about 42.09 mm to about 69 mm, or from about 39.09 mm to about 68.98 mm. However, other lengths are possible and encompassed within the scope of the present disclosure.

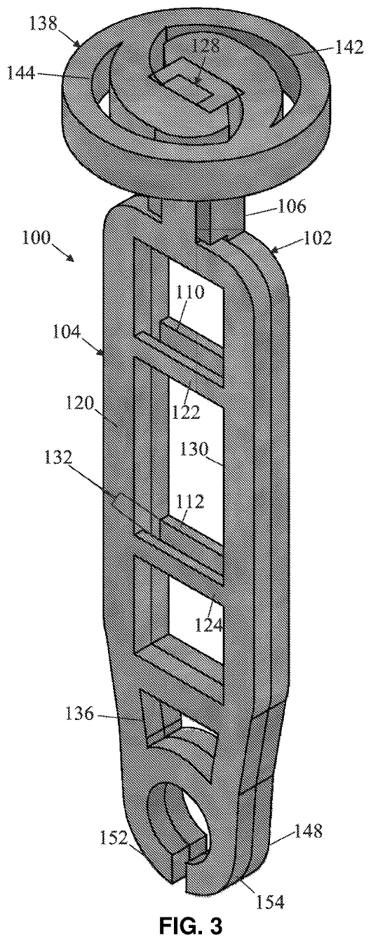

As shown in FIGS. 1, 6, 9, 11, the first body 102 can include a first locking portion 106, a first substrate portion 108, a first cross member 110, and a second cross member 112. The first locking portion 106 is configured to mate together with a portion of the second body 104, for example, as shown in FIGS. 3, 8, 14. With reference to FIGS. 1, 6, 9, 11, the first locking portion 106 can be, or can include, a groove 114 defined by the first body 102. The groove 114 is configured to receive a portion of the second body 104. In certain examples, the groove 114 is substantially u-shaped, as shown in FIG. 1.

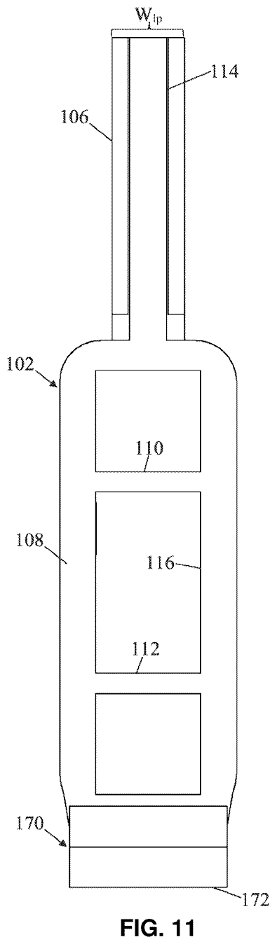

As shown in FIG. 11, the first locking portion 106 can have a width Wₗₚ in a range from about 0.70 mm to about 7.2 mm, from about 1 mm to about 5.4 mm, or from about 1.41 mm to about 3.6 mm. However, other widths are possible and encompassed within the scope of the present disclosure. With reference to FIG. 1, in certain examples, the first locking portion 106 has a thickness Tₗₚ in a range from about 0.1 mm to about 4 mm, from about 1 mm to about 3 mm, or about 1.5 mm to about 2 mm. While still referring to FIG. 1, the groove 114 can have a width W_{g} in a range from about 0.81 mm to about 3.26 mm, from about 1.08 mm to about 2.44 mm, or about 1.63 mm. However, other widths are possible and encompassed within the scope of the present disclosure.

With reference to FIGS. 1, 6, 9, 11, the first substrate portion 108 defines a first window 116. The first cross member 110 and the second cross member 112 extend across the first window 116. In operation of the substrate holder 100, the substrate 101 can be placed over the first cross member 110 and the second cross member 112. The first window 116 enables a fluid containing analytes to pass through the first body 102 to reach the substrate 101. As such, the first window 116 can be sized to substantially correspond to the size of the substrate 101, e.g., a thin film. During operation of the substrate holder 100, the first cross member 110 and the second cross member 112 can abut the substrate 101 and militate against the substrate 101 from passing through the first window 116. Desirably, the first cross member 110 and the second cross member 112 can also assist in militating against the substrate 101 from bending when the substrate holder 100 is placed in the sample.

As shown in FIGS. 2, 3, 4, 7, 8, 10, 13, the second body 104 can include a second locking portion 118, a second substrate portion 120, a third cross member 122, and a fourth cross member 124. The second locking portion 118 is configured to mate together with the first locking portion 106. For example, with reference to FIG. 2, the second locking portion 118 is a locking member 118 which is configured to be received by the groove 114 of the first locking portion 106 of the first body 102. As shown in FIG. 3, the first locking portion 106 of the first body 102 and the second locking portion 118 of the second body 104 form a substrate holder stem 128 when mated together. However, it should be appreciated that the first locking portion 106 and the second locking portion 118 may alternatively utilize other mating technologies including, but not limited to, a hinge, a living hinge, or a temporary adhesive.

With reference to FIG. 2, in certain examples, the locking member 118 has a width Wim in a range from about 0.81 mm to about 3.26 mm, from about 1.08 mm to about 2.44 mm, or about 1.63 mm or about 1.41 mm. While still referring to FIG. 2, the locking member 118 can have a thickness Tim in a range of from about 0.35 mm to about 1.42 mm, from about 0.47 mm to about 1.06 mm, or about 0.71 mm. However, other dimensions are possible and encompassed within the scope of the present disclosure.

The second substrate portion 120 defines a second window 130 as shown in FIGS. 2, 3, 4, 7, 8, 10, 13. The third cross member 122 and the fourth cross member 124 extend across the second window 130. In operation of the substrate holder 100, the substrate 101 is placed between the first cross member 110, the second cross member 112, the third cross member 122, and the fourth cross member 124. In particular, when the second body 104 is disposed over the first body 102, the first cross member 110 can be aligned and spaced apart from the third cross member 122 and the second cross member 112 can be aligned and spaced apart from the fourth cross member 124, to form a substrate gap 132 therebetween (as shown in FIG. 3) configured to receive the substrate 101. Desirably, the substrate holder 100 can hold the substrate 101 flat, which can cause the maximum surface area of the extraction phase to be used.

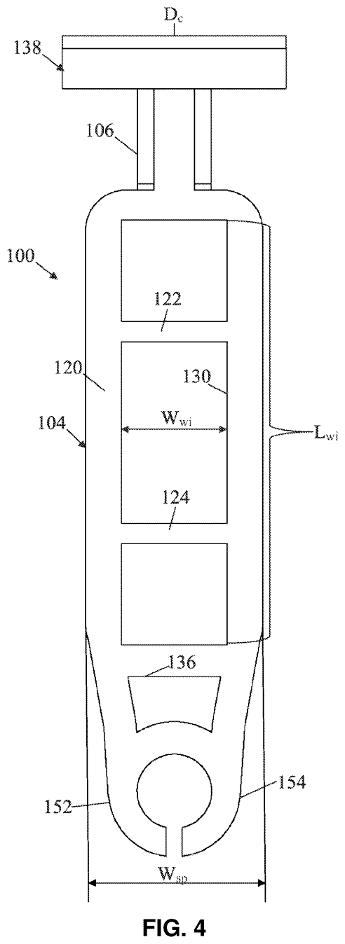

As shown in FIG. 4, the first substrate portion 108 and the second substrate portion 120 can have a width Wₛₚ in a range from about 4.37 mm to about 17.5 mm, from about 5.83 mm to about 13.12 mm, or about 8.75 mm. With continued reference to FIG. 4, the first window 116 and the second window 130 can have a length L_{wi} from about 5 mm to about 35 mm, from about 10 mm to about 30 mm, from about 15 mm to about 25 mm, or from about 20 mm to about 21 mm. As shown in FIG. 4, the first window 116 and the second window 130 can have a width W_{wi} from about 2 mm to about 10 mm, from about 3 mm to about 8 mm, or from about 5 mm to about 6 mm. However, other dimensions are possible and encompassed within the scope of the present disclosure. It should be appreciated that the first window 116 and the second window 130 can be sized to substantially correspond to the dimensions of the substrate 101. With reference to FIG. 3, in certain examples, the substrate gap 132 is a distance in the range of from about 0.35 mm to about 1.64 mm, from about 0.47 to about 1.23 mm, or from about 0.71 mm to about 0.82 mm.

The second window 130 enables a fluid containing analytes to pass through the second body 104 to reach the substrate 101. During operation of the substrate holder 100, the third cross member 122 and the fourth cross member 124 can abut the substrate 101 and militate against the substrate 101 from passing through the second window 130. Desirably, the third cross member 122 and the fourth cross member 124 can also assist in militate against the substrate 101 from bending when the substrate holder 100 is placed in the sample.

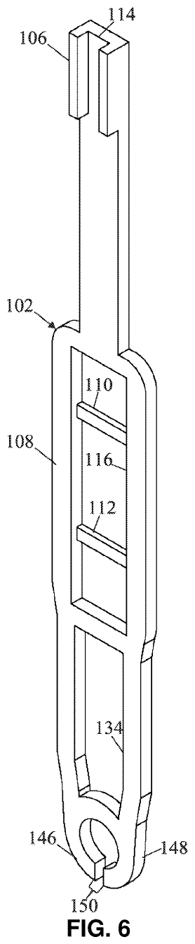

As shown in FIGS. 1, 6, the first substrate portion 108 of the first body 102 can further define a third window 134. The third window 134 can be defined adjacent to the first window 116. The first window 116 can be defined between the first locking portion 106 and the third window 134. Desirably, the third window 134 can allow fluid to flow through the first body 102 to avoid unnecessary resistance to the flow of water in the sample. With reference to FIGS. 2, 3, 7, 8, the second substrate portion 120 of the second body 104 can further define a fourth window 136. The fourth window 136 can be defined adjacent to the second window 130. The second window 130 can be defined between the second locking portion 118 and the fourth window 136. Desirably, the fourth window 136 can allow fluid to flow through the second body 104 to avoid unnecessary resistance to the flow of water in the sample.

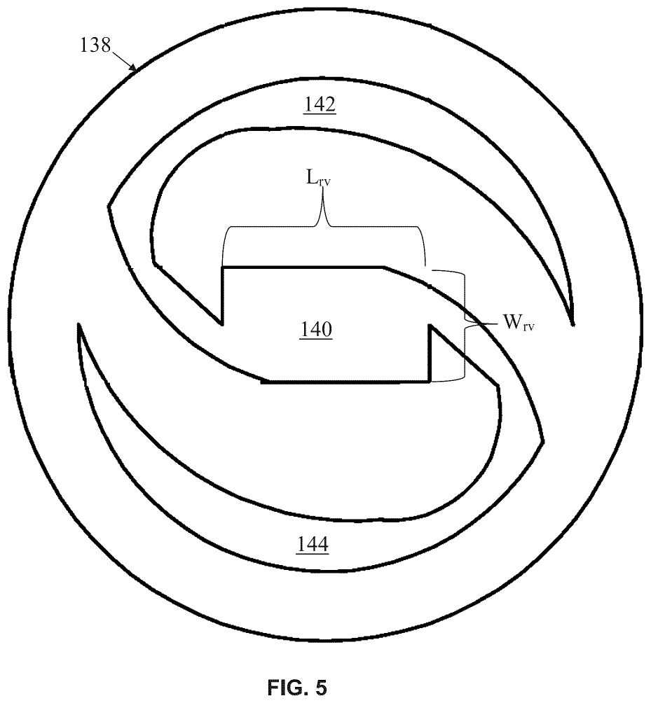

As shown in FIGS. 3, 4, 5, 8, the substrate holder 100 can further include a cap 138 that can be removably connected to the first body 102 and the second body 104. The cap 138 is configured to receive at least a portion of the substrate holder stem 128, e.g., as shown in FIG. 3. With reference to FIG. 5, the cap 138 can define a stem receiving void 140 configured to receive the portion of the substrate holder stem 128. Desirably, the cap 138 can facilitate holding the first body 102 and the second body 104 together when the substrate holder stem 128 is received by the cap 138. In addition, when the substrate holder 100 is disposed in a vial, the cap 138 can be configured to cover the top of the vial to hold the substrate holder 100 in a fixed position in the vial.

As shown in FIG. 4, the cap 138 can have a diameter De in a range from about 5.5 mm to about 22 mm, from about 7.33 mm to about 16.5 mm, or about 11 mm. With reference to FIG. 5, the stem receiving void 140 can have a width Wᵣᵥ in a range from about 1 mm to about 4 mm, from about 1.33 mm to about 3 mm, or about 2 mm. While still referring to FIG. 5, the stem receiving void 140 can have a length Lᵣᵥ in a range from about 1.8 mm to about 7.2 mm, from about 2.4 mm to about 5.4 mm, or about 3.6 mm. However, other dimensions are possible and encompassed within the scope of the present disclosure.

The cap 138 can further define additional voids to provide increased circulation to the vial and avoid pressure from building up in the vial. As shown in FIG. 5, the cap 138 can define a first curved void 142 and a second curved void 144. When viewed in combination, the stem receiving void 140, the first curved void 142, and the second curved void 144 can define a substantially s-shaped void.

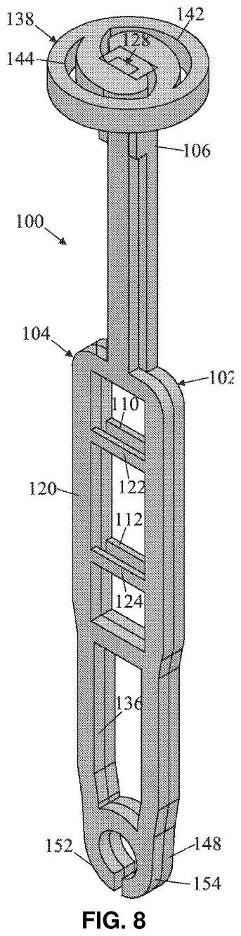

Now referring to FIGS. 1, 6, the first body 102 can include a first arm 146 and a second arm 148 extending from the first substrate portion 108. The first arm 146 and the second arm 148 curve towards each other. In certain examples, the first arm 146 and the second arm 148 curve towards each other and form a first stir bar gap 150 therebetween. With reference to FIGS. 2-4, 7, 8, the second body 104 can include a third arm 152 and a fourth arm 154 extending from the second substrate portion 120. The third arm 152 and the fourth arm 154 curve towards each other. In certain examples, the third arm 152 and the fourth arm 154 curve towards each other and form a second stir bar gap 156 therebetween. When the first body 102 and the second body 104 are combined, e.g., as shown in FIGS. 3, 8, the first arm 146, the second arm 148, the third arm 152, and the fourth arm 154, are configured to receive or otherwise accommodate a stir bar. Desirably, the stir bar can be used to stir the fluid in the sample while the substrate holder 100 is disposed within the sample.

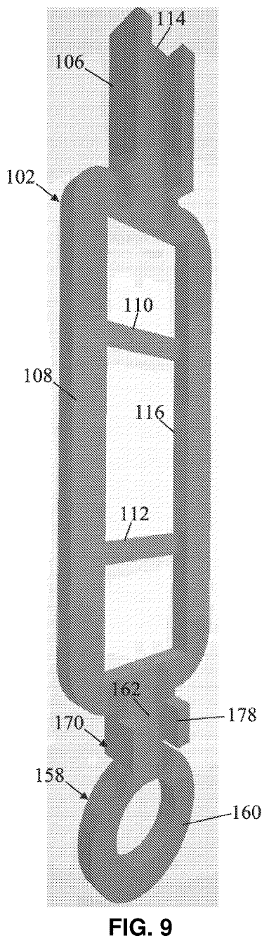

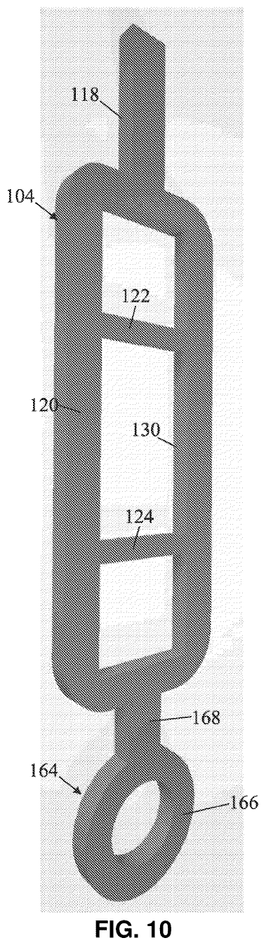

Referring now to FIG. 9, the first body 102 can include a first ring portion 158. The first ring portion 158 can include a first ring 160 and a first neck 162. The first ring 160 is configured to receive or otherwise accommodate a stir bar. The first neck 162 is disposed between the first substrate portion 108 and the first ring 160 and connects the first ring 160 to the first substrate portion 108. As shown in FIG. 10, the second body 104 can include a second ring portion 164. The second ring portion 164 can include a second ring 166 and a second neck 168. The second ring 166 is configured to receive or otherwise accommodate a stir bar. The second neck 168 is disposed between the second substrate portion 120 and the second ring 166 and connects the second ring 166 to the second substrate portion 120. Desirably, the stir bar can be used to stir the fluid in the sample while the substrate holder 100 is disposed within the sample.

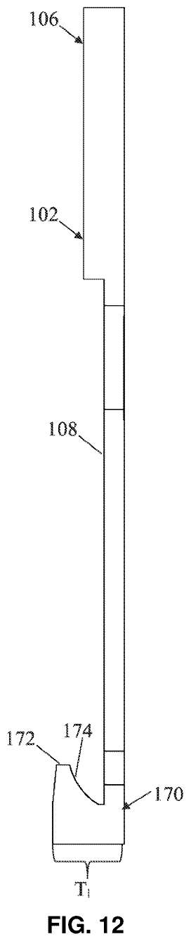

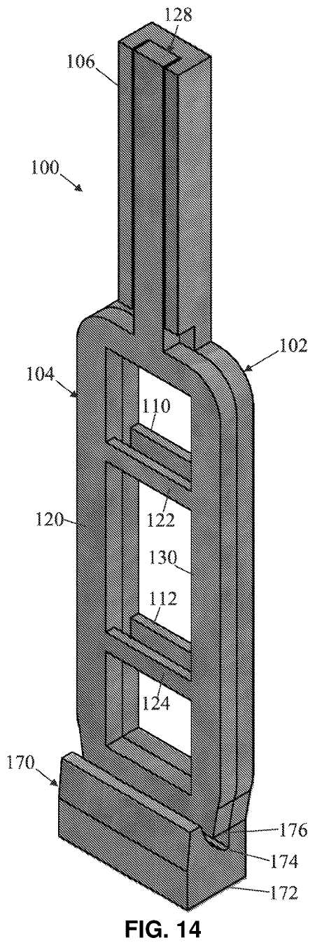

With reference to FIGS. 9, 11, 12, 14, the first body 102 can further comprise a third locking portion 170. The first substrate portion 108 is between the first locking portion 106 and the third locking portion 170. The third locking portion 170 is configured to mate together with a portion of the second body 104. For example, as shown FIG. 12, the third locking portion 170 can include a lip 172 oriented perpendicular to the first substrate portion 108. The lip 172 can define a second groove 174. The second groove 174 is configured to receive an edge 176 of the second body 104 that is opposite to the second locking portion 118 of the second body 104, e.g., as shown in FIG. 14. Desirably, the third locking portion 170 in this example can facilitate holding the first body 102 and the second body 104 together when a stir bar is not needed or possible to use, for example, when the sample is a body of water.

In another example, the third locking portion 170 can include a channel 178 defined on the first neck 162 of the first body 102, as shown in FIG. 9. The channel 178 is configured to receive the second neck 168. Desirably, the third locking portion 170 in this example can facilitate holding the first body 102 and the second body 104 together when a stir bar is needed or desired.

As shown in FIG. 12, the lip 172 can have a thickness T₁ in a range from about 1.77 mm to about 7.1 mm, from about 1.18 mm to about 2.65 mm, or about 3.55 mm. However, other thicknesses are possible and encompassed within the scope of the present disclosure.

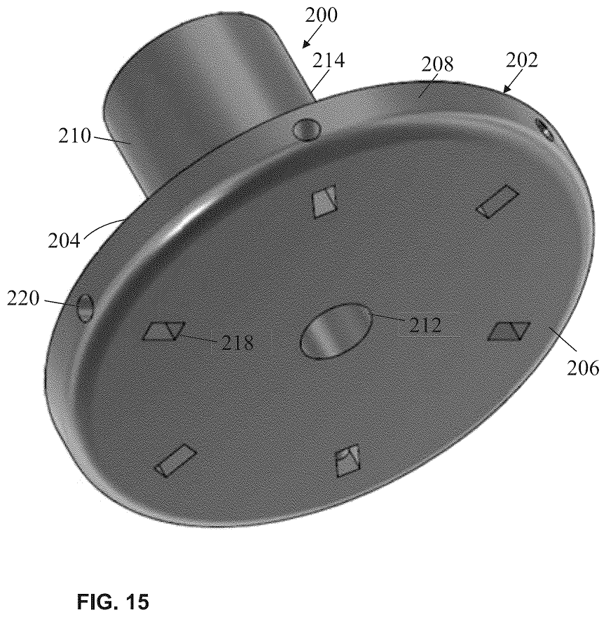

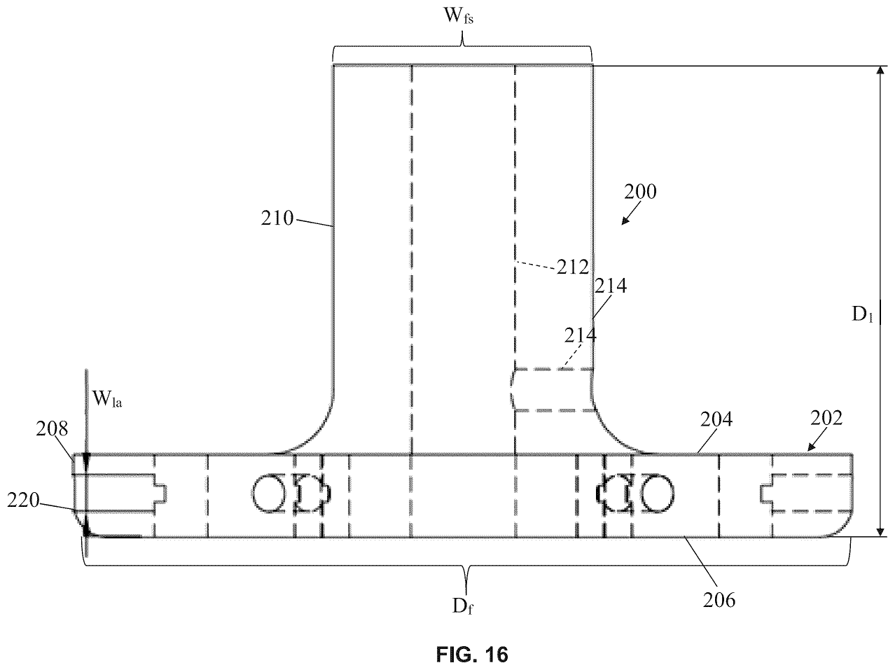

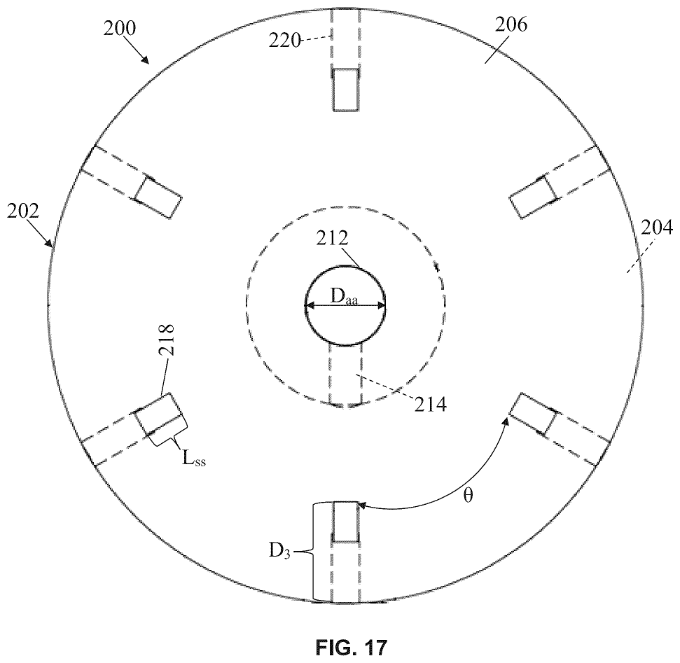

With reference to FIGS. 15-17, a substrate holder fixture 200 for the substrate holder 100 is shown. The substrate holder fixture 200 has a circular base 202 having a first face 204, a second face 206, and a fixture edge 208 between the first face 204 and the second face 206. As shown in FIG. 16, the first face 204 has a fixture stem 210 disposed thereon. The fixture stem 210 is configured to attach to an external device, such as a drone, drill, impact driver, or other type of tool. The fixture stem 210 can define an attachment aperture 212, which receives at least a portion of the external device, at a top of the fixture stem 210. In certain examples, the attachment aperture 212 is defined through the fixture stem 210, the first face 204, and the second face 206, e.g., as shown in FIGS. 15-17. Side walls of the attachment aperture 212 can be threaded to facilitate connection to the external device. With reference to FIGS. 16-17, the fixture stem 210 can include an attachment locking aperture 214 formed in a side 216 perpendicular to the top of the fixture stem 210. The attachment locking aperture 214 can be in communication with the attachment aperture 212. The attachment locking aperture 214 can be configured to receive a locking screw to lock the substrate holder fixture 200 to the external device.

As shown in FIG. 16, the fixture stem 210 can have a width Wis in a range from about 10 mm to about 40 mm, from about 13.33 mm to about 30 mm, or about 20 mm. However, other widths are possible and encompassed within the scope of the present disclosure. With continued reference to FIG. 16, a distance D₁ from the second face 206 to the top of the fixture stem 210 can be in a range from about 18.17 mm to about 72.7 mm, from about 24.23 mm to about 54.52, or about 36.35 mm. However, other distances are possible and encompassed within the scope of the present disclosure.

With reference to FIGS. 15, 17, the second face 206 can define one or more stem slots 218. Each of the stem slots 218 is configured to receive at least a portion of the substrate holder stem 128 of the substrate holder 100. The stem slots 218 can be defined spaced apart from each other. In addition, the stem slots 218 may also be arranged in a particular arrangement, for example the substantially circular arrangement shown in FIGS. 15, 17.

As shown in FIG. 17, each of the stem slots 218 can be spaced apart from each other at an angle θ in a range from about 30° to about 120°, from about 40° to about 90°, or about 60°. However, other angles are possible and encompassed within the scope of the present disclosure. While still referencing FIG. 17, the stem slots 218 can have a length Lₛₛ in a range from about 2.05 mm to about 8.2 mm, in a range from about 2.73 mm to about 6.15 mm, or about 4.1 mm. However, other lengths are possible and encompassed within the scope of the present disclosure.

With reference to FIGS. 15-16, the fixture edge 208 of the circular base 202 can define one or more locking apertures 220. Each of the locking apertures 220 is in communication with one of the stem slots 218. Each of the locking apertures 220 is configured to threadably receive a locking screw.

As shown in FIG. 17, a distance D₃ from the fixture edge 208 of the substrate holder fixture 200, through one of the locking apertures 220, to an opposite edge 220 of an associated one of the stem slots 218 can be in a range from about 5.12 mm to about 20.48 mm, from about 6.82 mm to about 15.36 mm, or about 10.24 mm. However, other distances are possible and encompasses within the scope of the present disclosure.

With reference to FIG. 16, the second face 206 can have a diameter D_{f} in a range from about 30 mm to about 120 mm, from about 40 mm to about 90 mm, or about 60 mm. While still referring to FIG. 16, the attachment aperture 212 can have a diameter Dₐₐ in a range from about 4 mm to about 16 mm, from about 5.33 mm to about 12 mm, or about 8 mm. As shown in FIG. 16, each of the locking apertures 220 can have a width W₁ₐ in a range from about 1.4 mm to about 5.6 mm, from about 1.86 mm to about 4.2 mm, or about 2.8 mm. However, other dimensions are possible and encompassed within the scope of the present disclosure.

In operation, a user can introduce the portion of the substrate holder stem 128 into one of the stem slots 218 and then insert a locking screw in the associated one of the locking apertures 220 to connect the substrate holder 100 to the substrate holder fixture 200. Then, the substrate holder fixture 200 can be connected to an external device, such as a drill or impact driver, to facilitate rotating the substrate holder fixture 200 and thereby cause all connected substrate holders 100 to rotate.

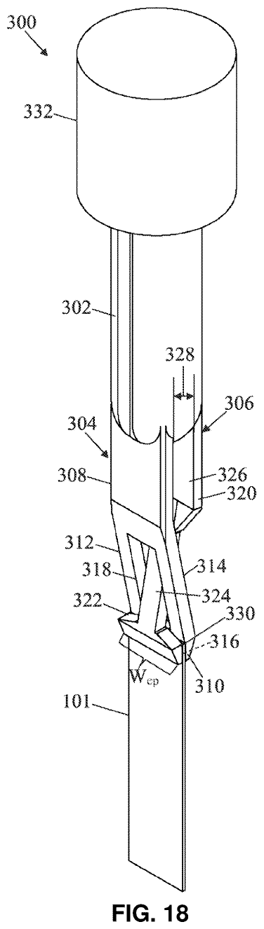

With reference to FIGS. 18, 19, 20, 21, 22, 23, a substrate holder 300 configured to hold the substrate 101 is shown. As shown in FIG. 18, the substrate holder 300 can include a main body 302, a first substrate arm 304, and a second substrate arm 306. The main body 302 can be composed of polylactic acid (PLA) filament. However, it should be appreciated that the main body 302 can be composed of different materials, including, but not limited to, acrylonitrile butadiene styrene (ABS), polyethylene terephthalate glycol (PETG), nylon, thermoplastic polyurethane (TPU), metals, 3D printed metals, and other polymers, resins, composites, or combinations thereof. In addition, the substrate holder 300 can be manufactured via 3D printing, or other processes.

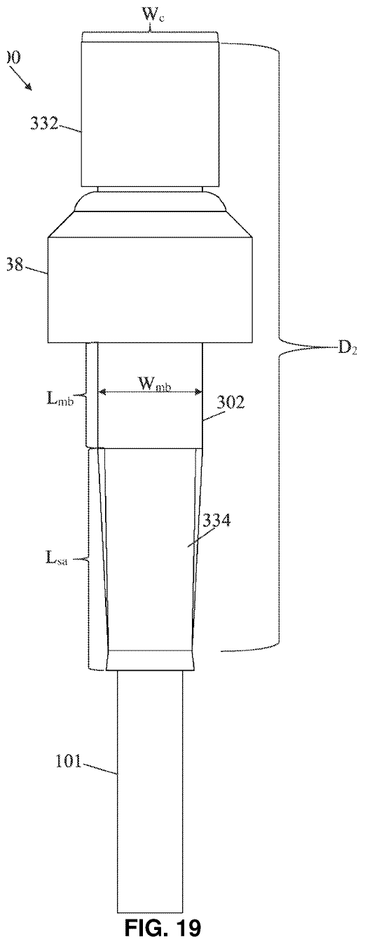

With reference to FIG. 19, the main body 302 can have a width W_{mb} in a range from about 4 mm to about 16 mm, from about 5.33 mm to about 12 mm, or about 8 mm. With continued reference to FIG. 19, the first substrate arm 304 and the second substrate arm 306 can have a length Lₛₐ in a range from about 8.45 mm to about 33.8 mm, from about 11.26 mm to about 25.35 mm, or about 16.9 mm. However, other dimensions are possible and encompassed within the scope of the present disclosure.

As shown in FIG. 18, the first substrate arm 304 extends from the main body 302. The first substrate arm 304 has a first flex portion 308, a first end portion 310, and a first intermediate portion 312. The first flex portion 308 defines a second substrate arm facing side 314 configured to face the second substrate arm 306. The first end portion 310 defines a first substrate side 316 that is opposite to the second substrate arm facing side 314. The first flex portion 308 is comprised of a material capable of flexing, deforming, or bending. The first intermediate portion 312 is sloped from the first flex portion 308 towards the first end portion 310. The first intermediate portion 312 defines an arm window 318 configured to receive a portion of the second substrate arm 306.

While still referring to FIG. 18, the second substrate arm 306 extends from the main body 302. The second substrate arm 306 has a second flex portion 320, a second end portion 322, and a second intermediate portion 324. The second flex portion 320 defines a first substrate arm facing side 326 configured to face the first substrate arm 304. The second flex portion 320 is spaced apart from the first flex portion 308 to define a first gap 328 between the first flex portion 308 and the second flex portion 320. The second flex portion 320 is composed of a material capable of flexing, deforming, or bending. The second end portion 322 defines a second substrate side 330 that is opposite to the first substrate arm facing side 326. The second substrate side 330 faces the first substrate side 316. The second intermediate portion 324 is sloped from the second flex portion 320 towards the second end portion 322. As shown in FIG. 18, the second intermediate portion 324 extends through the arm window 318 of the first substrate arm 304. The first end portion 310 and the second end portion 322 are configured to receive and sandwich the substrate 101. In operation, when the first flex portion 308 and the second flex portion 320 are compressed towards each other, the first end portion 310 and the second end portion 322 move away from each other to be spaced spart from each other (so as to release the substrate 101) until the compression ceases.

With reference to FIG. 18, the first end portion 310 and the second end portion 322 have a width Wₑₚ in a range from about 3.35 mm to about 13.4 mm, from about 4.46 mm to about 10.05 mm, or about 6.7 mm. However, other widths are possible and encompassed within the scope of the present disclosure.

As shown in FIGS. 18, 19, 20, 21, 23, the substrate holder 300 can include a cap 332. The cap 332 is disposed at an end of the main body 302 that is opposite to the first substrate arm 304 and the second substrate arm 306. The cap 332 can have a width We in a range from about 5.25 mm to about 21 mm, from about 7 mm to about 15.75 mm, or about 10.5 mm. The substrate holder 300 can have a length D₂ from the cap 332 to the first end portion 310 and the second end portion 322 in a range from about 20.95 mm to about 83.8 mm, from about 27.93 mm to about 62.85, or about 41.9 mm or 40.33 mm. However, other dimensions are possible and encompassed within the scope of the present disclosure.

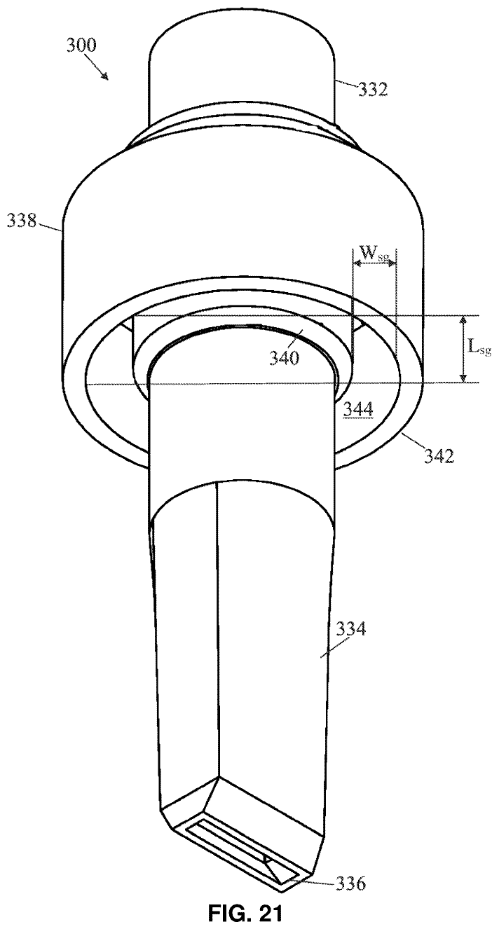

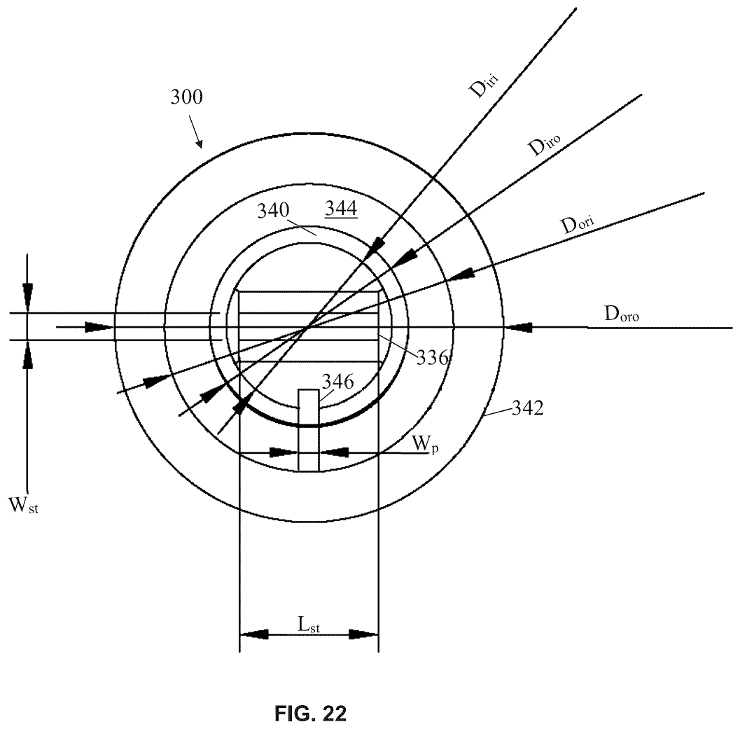

As shown in FIGS. 19, 20, 21, 23, the substrate holder 300 can include an enclosure 334 disposed over at least the first substrate arm 304 and the second substrate arm 306. With reference to FIGS. 21, 22, an end of the enclosure 334 defines a slot 336 formed adjacent to the first end portion 310 of the first arm and the second end portion 322 of the second substrate arm 306. The slot 336 is configured to receive at least a portion of the substrate 101 when the portion of substrate 101 is received by the first end portion 310 and the second end portion 322. The enclosure 334 is composed of a material capable of flexing, deforming, or bending. Desirably, the enclosure 334 can facilitate protecting the first substrate arm 304 and the second substrate arm 306 from outside elements.

As shown in FIGS. 19, 20, 21, 23, the substrate holder 300 can include a collar 338 circumscribing the main body 302. The collar 338 can be adapted to connect to a port in a gas sampling unit, such as a gas sampling bulb (with or without an O-ring). The collar 338 is disposed between the cap 332 and the first substrate arm 304 and the second substrate arm 306. With reference to FIGS. 21, 22, the collar 338 has an inner ring 340 and an outer ring 342. The inner ring 340 circumscribes the main body 302. The outer ring 342 circumscribes the inner ring 340. The outer ring 342 is spaced apart from the inner ring 340 to form a second gap 344 between the inner ring 340 and the outer ring 342. The second gap 344 can be configured to receive a portion of the port of gas sampling unit.

As shown in FIG. 19, the main body 302 can have a length L_{mb} from the collar 338 to an opposite end of the main body in a range from about 4.05 mm to about 16.2 mm, from about 5.4 mm to about 12.15 mm, or about 8.1 mm. With reference to FIG. 22, the inner ring 340 can have an inner diameter Dᵢᵣᵢ in a range from about 3.35 mm to about 13.4 mm, from about 4.46 to about 10.05 mm, or about 6.7 mm. The inner ring 340 can have an outer diameter Dᵢᵣₒ in a range from about 4 mm to about 16 mm, from about 5.33 mm to about 12 mm, or about 8 mm. The outer ring 342 can have an inner diameter Dₒᵣᵢ from about 5.8 mm to about 23.2 mm, from about 7.73 to about 17.4 mm, or about 11.6 mm. The outer ring 342 can have an outer diameter Dₒᵣₒ from about 7.8 mm to about 31.2 mm, from about 10.4 mm to about 23.4 mm, or about 15.6 mm. However, other dimensions are possible and encompassed within the scope of the present disclosure.

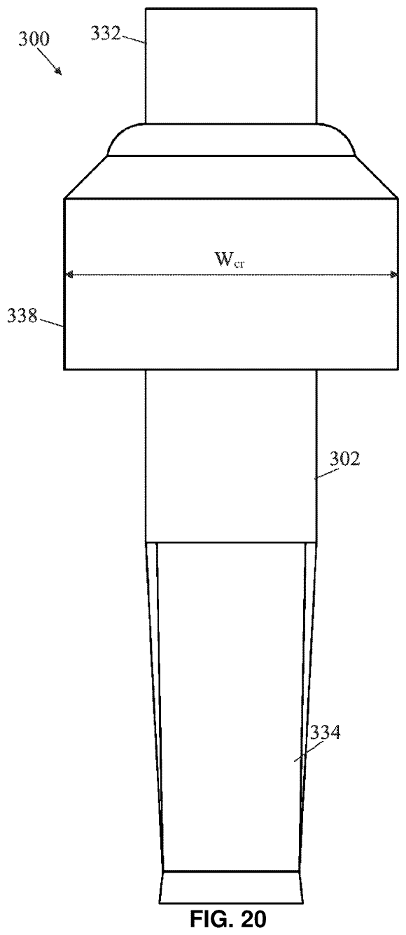

As shown in FIG. 20, the collar 338 has a width Wₑᵣ in a range from about 7.8 mm to about 31.2 mm, from about 10.4 mm to about 23.4 mm, or about 15.6 mm. With reference to FIG. 21, the second gap 344 can have a width W_{sg} in a range from about 1.02 mm to about 4.1 mm, from about 1.36 to about 3.07 mm, or about 2.05 mm. The second gap 344 can have a length L_{sg} in a range from about 1.22 mm to about 4.9 mm, from about 1.63 mm to about 3.67 mm, or about 2.45 mm.

As shown in FIG. 22, the outer ring 342 can have a projection 346 extending from the outer ring 342 and through the second gap 344. The projection 346 can be configured to abut a portion of the port of the gas sampling unit to lock the substrate holder 300 to the gas sampling unit. In certain examples, the projection 346 has a width Wₚ in a range from about 0.4 mm to about 1.6 mm, from about 0.53 mm to about 1.2 mm, or about 0.8 mm. However, other widths are possible and encompassed within the scope of the present disclosure.

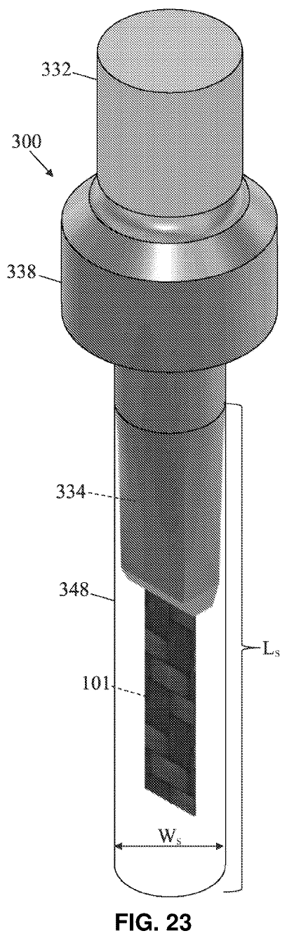

With reference to FIG. 23, the substrate holder 300 can further comprise a sheath 348 that is configured to be removably disposed over at least the substrate 101 when the substrate 101 is received by the first substrate arm 304 and the second substrate arm 306. Desirably, the sheath 348 can protect the substrate 101 from outside elements while the substrate 101 is being held by the substrate holder 300.

As shown in FIG. 23, the sheath 348 can have a width Wₛ in a range from about 4 mm to about 16 mm, from about 5.33 mm to about 12 mm, or about 8 mm. The sheath 348 can have a length Lₛ in a range from about 33 mm to about 132 mm, from about 44 mm to about 99 mm, or about 66 mm. With reference to FIG. 22, the slot 336 can have a width Wₛₜ in a range from about 2.8 mm to about 11.2 mm, from about 3.73 mm to about 8.4 mm, or about 5.6 mm. The slot 336 can have a length Lₛₜ in a range from about 0.54 mm to about 2.16 mm, from about 0.72 mm to about 1.62 mm, or about 1.08 mm. However, other dimensions are possible and encompassed within the scope of the present disclosure.

A method of using the substrate holder 100 can include applying the substrate 101 over the first window 116 of the first body 102 of the substrate holder 100; connecting the second body 104 of the substrate holder 100 to the first body 102, whereby connecting the second body 104 to the first body 102 causes the substrate to be sandwiched between the second body 104 and the first body 102; and/or disposing the substrate holder 100 in the sample comprising analytes.

A method for using the substrate holder fixture 200 can include inserting the substrate holder stem 128 into one of the stem slots 218 of the substrate holder fixture 200; connecting the substrate holder fixture 200 to a drill or other tool; introducing the substrate holder fixture 200 into the sample comprising analytes; and driving the drill or other tool to rotate the substrate holder fixture 200 in the sample.

A method of using the substrate holder 300 can include compressing the first flex portion 308 and the second flex portion 320 of the substrate holder 300; inserting the portion of the substrate 101 into the gap between the first end portion 310 and the second end portion 322; and releasing the first flex portion 308 and the second flex portion 320, whereby releasing the first flex portion 308 and the second flex portion 320 causes the first end portion 310 and the second end portion 322 to sandwich the portion of the substrate 101 therebetween; and/or inserting the substrate holder 300 in the sample comprising analytes. In certain examples, the method further includes disposing the sheath 348 over the substrate 101 for transportation and/or storage. In other examples, the method further includes compressing the first flex portion 308 and the second flex portion 320 of the substrate holder 300, whereby compressing the first flex portion 308 and the second flex portion 320 causes the first end portion 310 and the second end portion 322 to be spaced apart from each other so as to release the substrate 101 from the first end portion 310 and the second end portion.

In addition to offering superior protection for substrates, such as a thin film, the substrate holders and substrate holder fixture described herein facilitate more reproducible extractions compared to other holders under similar extractions conditions. The substrate holders allow users to employ thin film SPME devices for both in-lab and on-site extractions without the risk of loss or damage to the thin film. The substrate holders can facilitate reproducible extractions at high flows without altering the original structure of the thin film.

### EXAMPLES

### Thin Film SPME Holder Design

Traditional thin film holders can be prone to security issues and structural inconsistencies which can lead to damaging the thin film devices. To address these issues, thin film holders were designed to maximize the surface area by supporting in the film in a cage-like design (FIGS. 1-5) without pinching the film. The crossbar design can help the thin film device stay in place even at higher agitation speeds or more vigorous currents. The cage's dimensions were designed to prevent the film from bending or moving around when agitating. The flat-bottom design can be used in-vial or be coupled an extraction device, such as a drill, drone, etc. The other design contains a groove to attach stir bars and can be advantageous for in-vial extractions. The addition of the stir bar to the holder improves the extraction kinetics by moving the thin film SPME device through a solution as opposed to the typical extraction where the sample is agitated around the stationary thin film. The flat-bottom design may be more useful in onsite applications as the design is more compact and less likely to contact debris flowing in waterways.

A sampling head was also developed which can be coupled to extraction devices, such as drills and drones. The sampling head was 3D printed and contained 6 slots intended for the TF holders, including the TF holders mentioned previously. The slots allow for multiple simultaneous extractions to be performed with a single use of the sampling head. In addition, the slots can facilitate varying the thin film characteristics to extract a wider range of analytes by changing the chemical makeup of the thin film SPME device. The number of slots can be scalable to permit additional or less TF holders.

### Chemical Standards

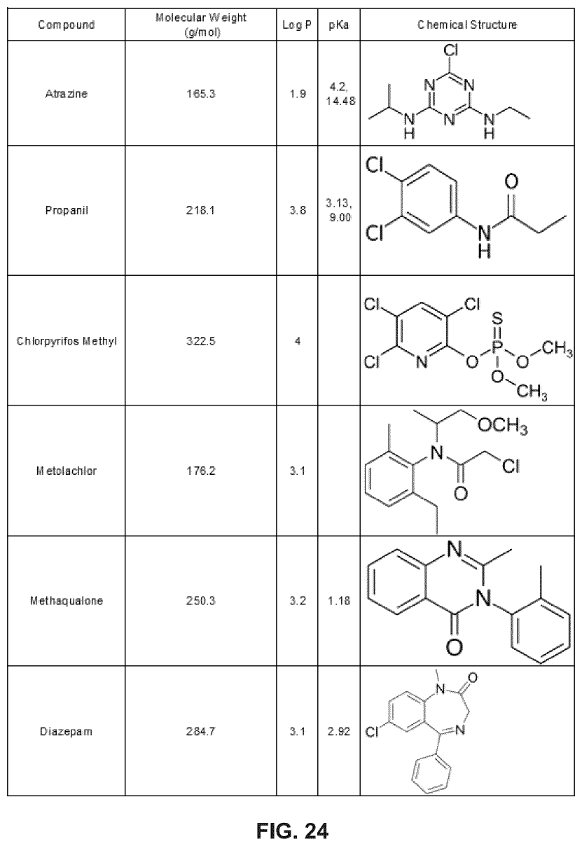

Chemical standards used during the examples include: diazepam, methaqualone, atrazine, metolachlor, chlorpyrifos methyl, and propanil. These chemical standards were purchased by Sigma Aldrich (St. Louis, MO, USA). Solutions used were 50 ppb (50 ng/mL) after dilution to the desired working sample volume. These molecules were selected as the target analytes because they are common pharmaceuticals and pesticides that could be found polluting waterways. The properties of each analyte are listed in FIG. 24. The DVB/PDMS thin film SPME devices were provided by Gerstel (Gerstel, Inc., Linthicum, MD, USA). Simulated sea water was prepared using “Sea-Salt” sold by Lake Products Company LLC. (Florissant, MO, USA) following the provided instructions.

### 3D Printing

The thin film holders were designed in Fusion360 and printed using polylactic acid (PLA) filament. Following 3D printing best practice, the holders were sprayed with hairspray during the printing process to prevent sticking or stringy fibers.

### Thin Film Holder Comparison

The thin film holders were compared in a series of in-vial extractions using a range of drug and pesticide analytes. The comparison was performed using DVB/PDMS thin films. Extractions were performed for 12 minutes using varying speeds: 600, 900, 1200, and 1500 rpm. At higher speeds, the two traditional holders had issues with bending and damaging the thin film. In experiments where the thin film slipped, the thin film was desorbed, and the extraction was performed again. For example, the commercial Gerstel holder needed 6 attempts to properly complete a triplicate of 12-minute extractions. In the event that the SPME device was damaged, a new film was conditioned and prepared before restarting the agitation set across all 3 holders to ensure an accurate comparison. The incomplete extraction results or extractions that needed restarted were not included in the overall comparison.

### Plastic Leaching

The Polylactic acid (PLA) filament used for 3D printing is typically stable under pure water conditions but may began to deteriorate in saltwater conditions. To see if the 3D printed filament can leach into the water, holders were placed into solutions at environmentally relevant pH, salinity, and temperatures. pH ranged from 6-9 and was adjusted with HCl or NaOH. Saltwater solutions were prepared using a simulated salt intended for replicating ocean water. The salt mixture contains common sea water salts including NaCl, MgCl₂, Na₂SO₄, KCl and CaCl₂) in a ratio analogous to real sea salt. The directed salt:water ratio was designated “100%” and salt amounts were adjusted accordingly to reach 0%-125% salinity to simulate waterways from fresh water-briny water. 20° C., 25° C., and 30° C. were selected as temperatures as these temperatures will show signs of polymer degradation faster than typical environmental water temperatures which can be much colder. Plastics were allowed to sit in solution for one week to see if any polymer degradation had occurred and to then indicate if using 3D printed holders can pollute the sampled water.

### Instrumentation

Experiments were performed using Gas Chromatography-Mass spectrometry (GC-MS) using an Agilent 7890 A GC (Agilent Technologies, Santa Clara, CA, USA) with an Agilent 5977 B MS system (Agilent Technologies, Santa Clara, CA, USA). The column used for analysis was a DB-5 MS column (30 m×250 μm×0.25 μm, Agilent Technologies, Santa Clara, CA, USA). Ultra-high purity helium was used as the carrier gas at a flow rate of 1 mL/min. The temperature gradient used began with a hold at 110° C. for 3 min followed by a temperature ramp of 20° C./min to 300° C. and held for 5 min. The thin film SPME sampled were desorbed in the Gerstel Thermal Desorption Unit (TDU; GERSTEL Inc., Linthicum, MD, USA) and cryo-focused with a cooled injection system (CIS; Gerstel, Linthicum, MD, USA). The TDU held a temperature of 290° C. for 12 minutes prior to sample separation. The MS was operated in full scan mode from 45-400 m/z with an electron ionization (EI) source at 70 eV.

The temperature ramp was modified for the plastic leaching experiment set. This method started at 30° C. and held for 5 minutes before ramping to 300° C. at a rate of 12° C./min. The mass range was also reduced from 45-400 m/z to 40-400 m/z. The other instrumental parameters remained unchanged.

### Results and Discussion

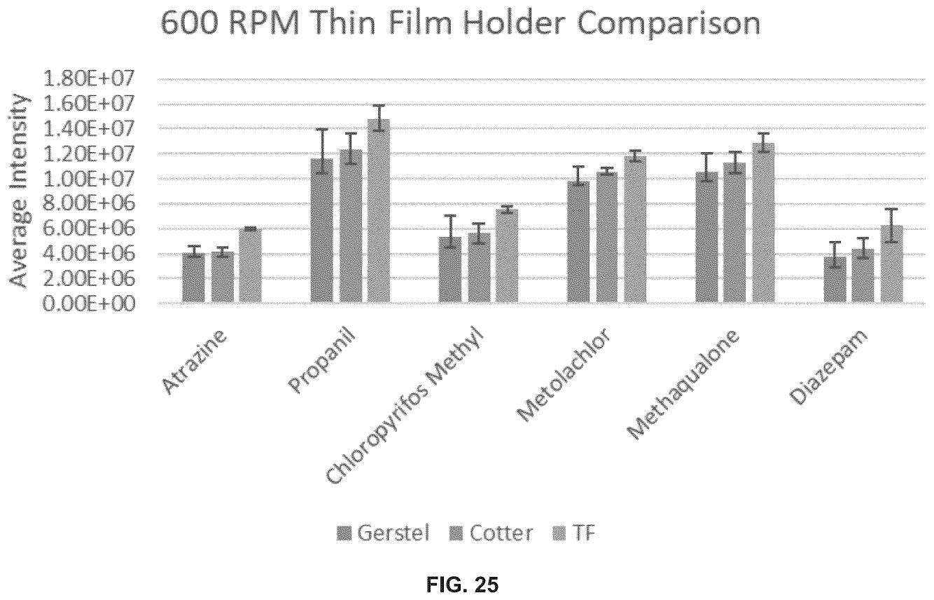

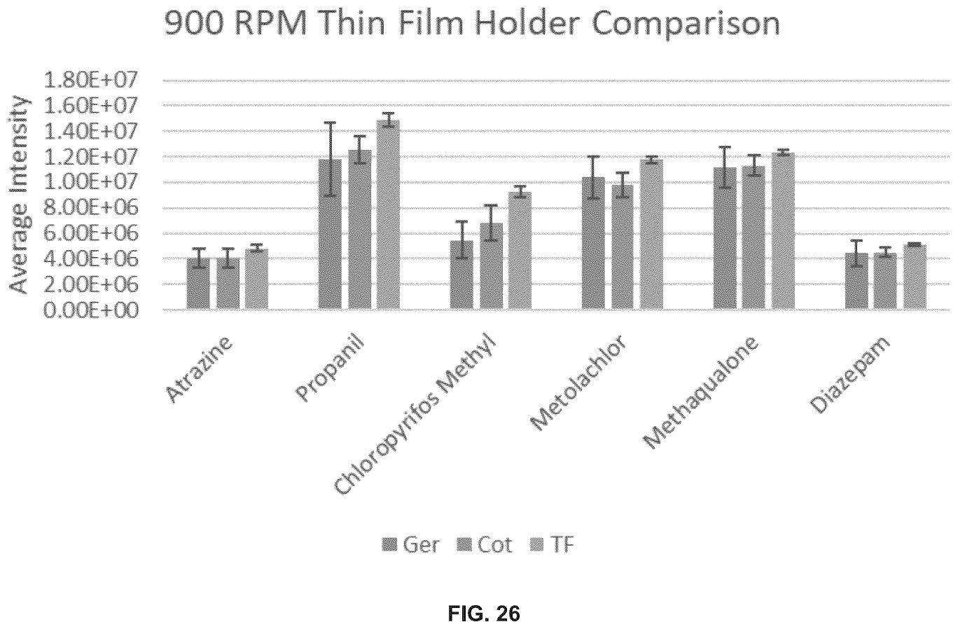

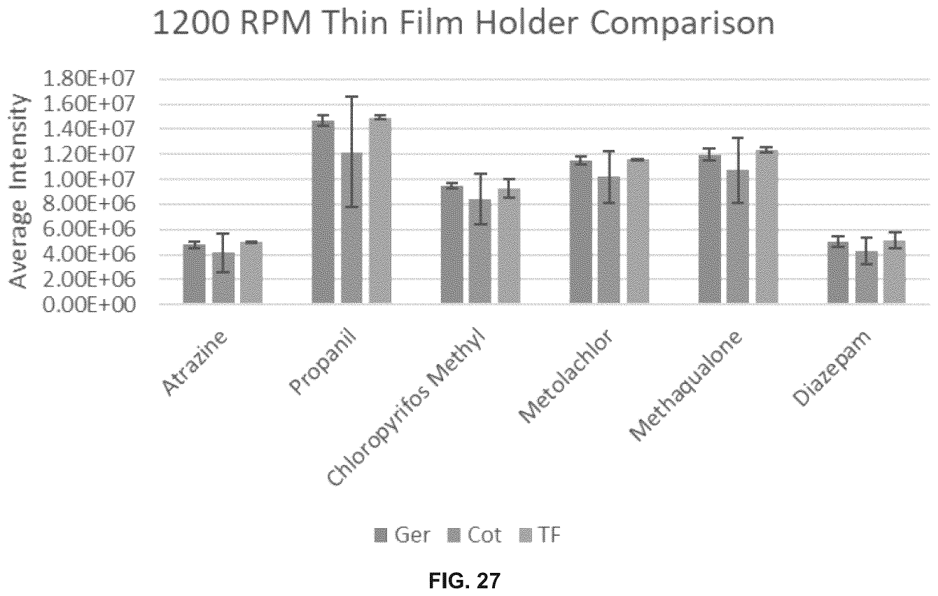

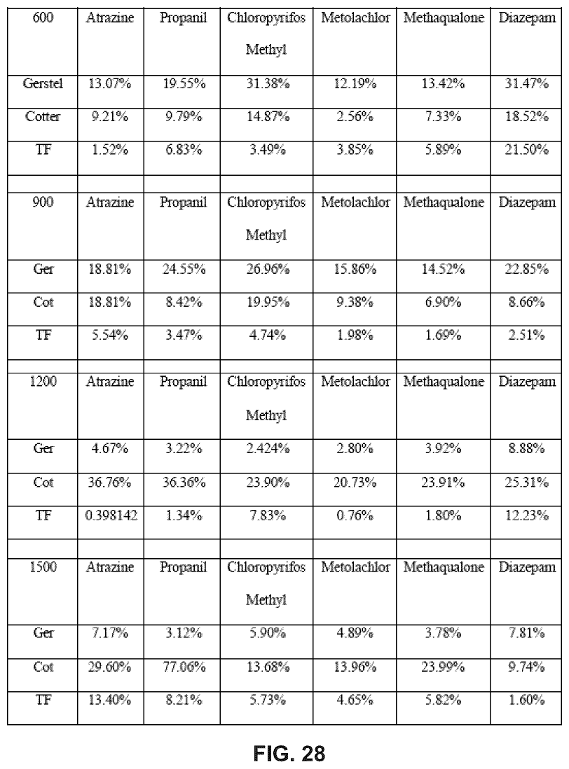

After analysis, the 3D printed holder design offers better results at all of the selected agitation speeds based on both amount extracted and reproducibility (% RSD). FIGS. 25-27 show the comparison between the holders at different agitation speeds. As described previously, the cotter pin saw a large decrease in reproducibility at higher agitation speeds due to bending of the thin film. At first glance, the Gerstel holder has comparable results to the 3D printed holder with slightly worse reproducibility, however it is worth noting that the Gerstel holder required many more attempted replicates to acquire the data shown due to the film slipping from the holder, especially at higher agitation speeds (>1000 rpm). FIG. 28 shows the calculated % RSD for each holder and agitation speed, confirming that the improved design is able to outperform the other holder designs.

### Thin Film Interference Comparison

The arrangement when using multiple thin films was tested to see any potential interferences. After testing, the “para” arrangement of thin films showed the greatest amount of interference. This was determined by comparing the reproducibility of extraction in a 30 min extraction and seeing that the para position had a large increase in % RSD indicating a less reproducible extraction.

### PLA Polymer Degradation

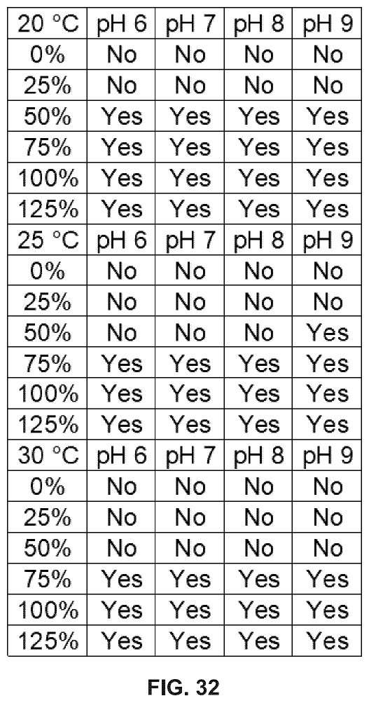

To check for the PLA polymer degradation, each solution was analyzed for the m/z of lactic acid, 45. The PLA polymer is built from lactic acid monomers so when PLA undergoes degradation, lactic acid is generated, therefore any lactic acid detected indicates PLA degradation. Salinity plays a large role in the degradation of PLA. FIG. 32 lists each temperature, salinity, and pH. Solutions labeled “No” had no detectible PLA monomers or dimers. Solutions labeled “Yes” had an instrumental response above the instrumental noise. Solutions tended to have more dimers present than monomers, but presence of either molecule confirmed PLA degradation for the goal of this experiment. Each holder that was “leached” had no change to the overall structure or functionality after the week equilibrating in solution and could continue to be used.

### CONCLUSION

Thin film SPME can be used for greener sampling of environmental systems, but the lack of a reliable thin film SPME holder makes it a risky endeavor when the thin film can easily slip away. The 3D printed holders described in these examples address that issue while also protecting the thin film from damage that can be caused by more secure holders, such as cotter pins. The holders also outperform the current holders' performance in a laboratory setting, providing better extraction reproducibility and with a simple design that is less likely to damage the thin film itself. The 3D printed components show mild polymer degradation after extended periods of exposure to harsh briny water, but the functionality remained unchanged, making the holders useable for applications in both bodies of freshwater and saltwater when operated properly.

Certain embodiments of the apparatuses, systems, devices, and methods disclosed herein are defined in the above examples. It should be understood that these examples, while indicating particular embodiments of the invention, are given by way of illustration only. From the above discussion and these examples, one skilled in the art can ascertain the essential characteristics of this disclosure, and without departing from the spirit and scope thereof, can make various changes and modifications to adapt the apparatuses, systems devices, and methods described herein to various usages and conditions. Various changes may be made, and equivalents may be substituted for elements thereof without departing from the essential scope of the disclosure. In addition, many modifications may be made to adapt a particular situation or material to the teachings of the disclosure without departing from the essential scope thereof.

What is claimed is:

1. A substrate holder comprising:
a first body having a first locking portion, a first substrate portion, a first cross member, and a second cross member, the first substrate portion defining a first window, wherein the first cross member and the second cross member extend across the first window; and
a second body having a second locking portion, a second substrate portion, and a third cross member, the second substrate portion defining a second window, wherein the third cross member and the fourth cross member extend across the second window;
wherein when the second body is disposed on the first body, the first locking portion and the second locking portion mate together to form a substrate holder stem, the first cross member is spaced apart from the third cross member, and the second cross member is spaced apart from the fourth cross member.

2. The substrate holder of claim 1, wherein the second locking portion is a locking member and the first locking portion defines a first groove configured to receive the locking member when the first body is disposed on the second body.

3. The substrate holder of claim 1, wherein the first substrate portion defines a third window formed adjacent to the first window and the second substrate portion defines a fourth window adjacent to the second window.

4. The substrate holder of claim 1, further comprising a cap configured to receive at least a portion of the substrate holder stem.

5. The substrate holder of claim 4, wherein the cap defines a substantially s-shaped void.

6. The substrate holder of claim 1, wherein the first body has a first arm and a second arm that curve towards each other and the second body has a third arm and a fourth arm that curve towards each other.

7. The substrate holder of claim 1, wherein the first body further comprises a third locking portion, and wherein the first substrate portion is between the first locking portion and the third locking portion.

8. The substrate holder of claim 7, wherein the third locking portion of the first body defines a second groove configured to receive at least an edge of the second body.

9. The substrate holder of claim 8, wherein the third locking portion of the first body includes a lip oriented perpendicular to the first substrate portion and the second groove is formed in the lip of the first body.

10. The substrate holder of claim 1, further comprising a substrate holder fixture having a circular base with a fixture stem, the circular base defining a stem slot configured to receive the substrate holder stem.

11. The substrate holder of claim 10, wherein the circular base defines a locking aperture in communication with the stem slot, the aperture configured to receive a locking screw.

12. The substrate holder of claim 11, wherein the circular base defines a plurality of stem slots spaced apart from each other.

13. A substrate holder comprising:
a main body;
a first substrate arm extending from the main body, the first substrate arm having
a first flex portion defining a second substrate arm facing side,
a first end portion defining a first substrate side opposite to the second substrate arm facing side, and
a first intermediate portion sloped from the first flex portion towards the first end portion, the first intermediate portion defining an arm window; and
a second substrate arm extending from the main body, the second substrate arm having
a second flex portion spaced apart from the first flex portion to define a first gap therebetween, the second flex portion defining a first substrate arm facing side,
a second end portion defining a second substrate side opposite to the first substrate arm facing side, the second substrate side facing the first substrate side, and
a second intermediate portion sloped from the second flex portion towards the second end portion and extending through the arm window of the first substrate arm,
wherein the first end portion and the second end portion are configured to receive and sandwich a substrate, and wherein compressing the first flex portion and the second flex portion causes the first end portion and the second end portion to be spaced apart from each other.

14. The substrate holder of claim 13, further comprising a cap disposed at an end of the main body opposite to the first substrate arm and the second substrate arm.

15. The substrate holder of claim 13, further comprising an enclosure disposed over at least the first substrate arm and the second substrate arm.

16. The substrate holder of claim 15, wherein an end of the enclosure defines a slot formed adjacent to the first end portion of the first substrate arm and the second end portion of the second substrate arm, and wherein the slot is configured to receive at least a portion of the substrate when the portion of the substrate is received by the first end portion and the second end portion.

17. The substrate holder of claim 13, further comprising a collar circumscribing the main body.

18. The substrate holder of claim 17, wherein the collar has an inner ring circumscribing the main body.

19. The substrate holder of claim 18, wherein the collar has an outer ring spaced apart from the inner ring to form a second gap therebetween.

20. A method for using a substrate holder comprising:
applying a substrate over a first window of a first body of the substrate holder, the first body having a first locking portion, a first substrate portion, a first cross member, a second cross member, the first substrate portion defining the first window, wherein the first cross member and the second cross member extend across the first window; and
connecting a second body of the substrate holder to the first body, the second body having a second locking portion, a second substrate portion, a third cross member, and a third cross member, the second substrate portion defining a second window, wherein the third cross member and the fourth cross member extend across the second window, whereby when the second body is connected to the first body, the first locking portion and the second locking portion mate together to form a substrate holder stem, the first cross member is spaced apart from third cross member, and the second cross member is spaced apart from the fourth cross member.
